(19) United States
(12) Patent Application Publication
(10) Pub. No.: US 2010/0247413 A1
(43) Pub. Date: Sep. 30, 2010

(54) LUMINESCENT SAMARIUM-DOPED TITANIUM DIOXIDE

(75) Inventor: Carmine Torardi, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. Du Pont De Nemours and Company, Wilmington, DE (US)

(21) Appl. No.: 12/744,213

(22) PCT Filed: Dec. 18, 2008
(86) PCT No.: PCT/US08/87355

§ 371 Date: May 21, 2010

Related U.S. Application Data
(60) Provisional application No. 61/015,333, filed on Dec. 20, 2007.

(51) Int. Cl. C01F 17/00

(52) U.S. Cl. 423/263

(57) ABSTRACT

This disclosure relates to a process for making luminescent titanium dioxide, comprising: precipitating a halide salt and a hydrolyzed compound comprising titanium from a reaction mixture comprising a source of samarium, a titanium starting material selected from the group consisting of titanium tetrachloride, titanium oxychloride, and mixtures thereof, a base selected from the group consisting of ammonium hydroxide, ammonium carbonate, ammonium bicarbonate, tetramethyl ammonium hydroxide or tetraethyl ammonium hydroxide or mixture thereof, and a solvent selected from the group consisting of ethanol, n-propanol, i-propanol, dimethyl acetamide, alcoholic ammonium halide and aqueous ammonium halide and mixtures thereof to form a precipitate; and removing the halide salt from the precipitate to recover a samarium-doped oxide of titanium.

### CROSS REFERENCE TO RELATED APPLICATIONS

This application claims the benefit of U.S. Provisional Application No. 61/015,333 filed Dec. 20, 2007 which is incorporated herein by reference in its entirety.

This application is related to Provisional Application Ser. No. 61/001,841 filed on Nov. 5, 2007 which is related to Ser. No. 11/393,293 which is a continuation-in-part of application Ser. No. 11/172,099, filed on Jun. 30, 2005 which is a continuation in part of application Ser. No. 10/995,968, filed on Nov. 23, 2004 which are incorporated herein by reference in their entireties.

### FIELD OF THE DISCLOSURE

This disclosure relates to samarium-doped titanium dioxide and processes for making samarium-doped titanium dioxide which is photoluminescent.

### BACKGROUND

Rare earth doped mesoporous titania thin films which have visible and near-IR luminescence are described in Frindell et al. “Visible and near-IR Luminescence Via Energy Transfer In Rare Earth Doped Mesoporous Titania Thin Films With Nanocrystalline Walls”, Journal of Solid State Chemistry (2003), 172(1), 81-88. The process for making the doped mesoporous titania thin films employs rare earth ions (Sm³⁺, Eu³⁺, Yb³⁺, Nd³⁺, Er³⁺). As noted in the article, the photoluminescent spectra show that europium ions are located in glassy amorphous titania regions near the interface between the anatase nanocrystallites, rather than included as substituted sites in the nanocrystal structure. The sol-gel synthesis method used to make the titania thin films is complex and costly.

The impact on crystal structure of grinding samarium-doped titanium dioxide made by precipitation of titanium dioxide from ammonium hydroxide and titanium tetrachloride is described by Hayakawa, S. et al. in “Structure and the Crystal Field of Samarium-Doped Titanium Dioxide Effects of Formation Conditions and Grinding on the Fluorescence”, Zairyo (1974), 23(250), 531-5. The precipitation method is a less complex and costly process than the sol-gel synthesis described in Frindell et al., but the resulting titanium dioxide product may not be readily dispersible.

In Wang et al., Journal of Molecular Catalysis A: Chemical (2000), 151(1-2), 205-216, “The Preparation, Characterization, Photoelectrochemical and Photocatalytic Properties of Lanthanide Metal-ion-doped TiO₂ Nanoparticles” the photo response of Sm³⁺-doped TiO₂ was described as not being as comparable as that of other lanthanide metal-ion-doped TiO₂, but was said to be a little larger than that of undoped TiO₂. There the TiO₂ nanoparticles are made by a hydrothermal method. There is a need for a simpler, less costly process for making luminescent titanium dioxide nanoparticles.

### SUMMARY OF THE DISCLOSURE

The disclosure relates to luminescent titanium dioxide, comprising:

precipitating a halide salt and a hydrolyzed compound comprising titanium from a reaction mixture comprising a source of samarium, a titanium starting material selected from the group consisting of titanium tetrachloride, titanium oxychloride, and mixtures thereof, a base selected from the group consisting of ammonium hydroxide, ammonium carbonate, ammonium bicarbonate, tetramethyl ammonium hydroxide or tetraethyl ammonium hydroxide or mixture thereof, and a solvent selected from the group consisting of ethanol, n-propanol, i-propanol, dimethyl acetamide, alcoholic ammonium halide and aqueous ammonium halide and mixtures thereof to form a precipitate; and

removing the halide salt from the precipitate to recover a samarium-doped oxide of titanium.

In one embodiment the samarium is included as substituted sites in the titanium dioxide crystal structure.

### BRIEF DESCRIPTION OF THE FIGURES

FIG. 1 depicts a scanning electron microscope (SEM) image of calcined powder of Comparative Example A.

FIG. 2 depicts the X-ray powder diffraction pattern of the product of the process to make TiO₂ using TiCl₄ and NH₄OH in aqueous saturated NH₄Cl as described in Example 1.

FIG. 3 depicts a scanning electron micrograph of the product of the process of Example 3.

FIG. 4 depicts a scanning electron micrograph of the product formed in Example 4.

FIGS. 5 and 6 are scanning electron micrographs of the product formed in Example 5.

FIG. 7 is a plot of the excitation spectrum and emission spectrum of the product formed in Example 20.

### DETAILED DESCRIPTION

The present disclosure is directed to a process for forming luminescent, typically photoluminescent, samarium-doped titanium dioxide.

The titanium dioxide product can be mesoporous. As used herein, the term “mesoporous” means structures having an average pore diameter from about 20 up to and including about 800 Å (about 2 to about 80 nm). The average pore diameter can, however, vary depending upon the metal oxide and its morphology. For a crystalline oxide of titanium the average pore diameter is at least about 200 Å (about 20 nm) and can be as high as about 500 Å (about 50 nm). More typically, the crystalline oxide of titanium can have an average pore diameter of at least about 200 Å (about 20 nm) up to and including about 450 Å (about 45 nm).

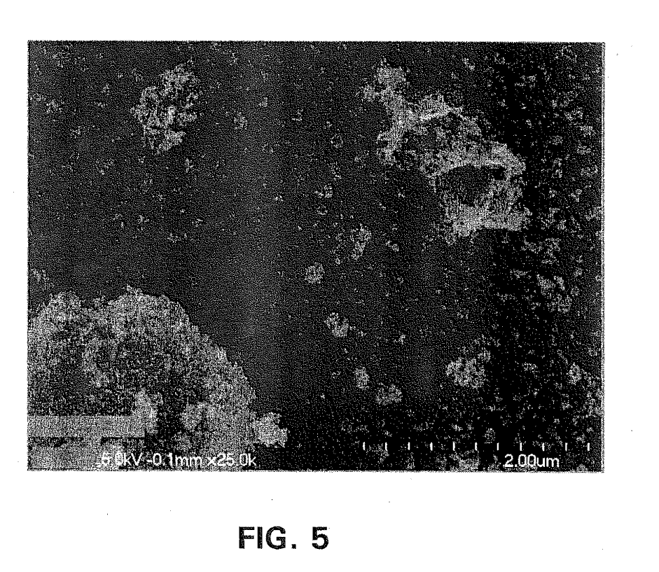

As best shown in FIG. 5, the microstructure product of this disclosure can be a sponge-like network of titanium oxide particles. As described herein, and as shown in the scanning electron micrographs of the Figures, the product of this disclosure comprises pores, the pores being interstices within an agglomerate of metal oxide particles and/or crystals.

Pore volumes and pore diameters referred to herein are determined by nitrogen porosimetry, and the surface areas are determined by BET.

A mesoporous samarium-doped anatase titanium dioxide can be made by the instant process. Additionally, loosely agglomerated mesoporous samarium-doped anatase titanium dioxide can form which is readily dispersed.

The process of this disclosure uses a porogen. A porogen is a substance that can create porous structures by functioning as a template for the microstructure of the titanium oxide of this disclosure. The porogen can be removed to recover a mesoporous titanium oxide.

In one embodiment of the disclosure, the porogen is ionic. When the porogen is ionic it can be formed in situ from the titanium compound or the solvent, or both, and a base. The titanium compound or the solvent can function as the source of the anion for the ionic porogen. The base can function as the source of the cation for the ionic porogen.

Alternatively, an ionic porogen can be added during the process, for example by addition of ammonium chloride to a mixture of a hydrolyzed compound comprising titanium and a liquid medium. When the process is a continuous one, the addition of the porogen to the mixture of hydrolyzed compound comprising titanium and liquid medium is done by any convenient method. When the process is a batch process, any method of adding one material to another can be used.

The ionic porogen can be a halide salt. Typically, the halide salt is an ammonium halide which can optionally contain lower alkyl groups. The lower alkyl groups can be the same or different and can contain from 1 up to and including about 8 carbon atoms, typically less than about 4 carbon atoms. Longer chain hydrocarbons for the alkyl group of the ammonium halide can be detrimental in making a calcined product because of charring; however, the longer chain hydrocarbons, typically over 4 up to and including about 10 carbon atoms, or even higher, would not be detrimental in making an amorphous product. Specific examples of ammonium halides containing lower alkyl groups include, without limitation, tetramethyl ammonium halide, and tetraethyl ammonium halide. The halide can be fluoride, chloride, bromide, or iodide. Even more specifically, the halide is chloride or bromide. The ionic porogen can be a mixture of halide salts such as a mixture of ammonium halide, tetramethyl ammonium halide and tetraethyl ammonium halide.

The porogen can be removed from the product of this disclosure to recover a mesoporous titanium oxide. Any suitable method for removing the porogen can be used. Contemplated methods for removing the porogen include washing, calcining, subliming and decomposing. It has been found that the choice of technique for removing the porogen depends upon whether a substantially or completely crystalline material is desired or whether an amorphous material is desired. When an amorphous material is desired the porogen can be removed by washing. When a crystalline material is desired the porogen can be removed by volatilizing, such as calcining.

The titanium starting material can include titanium tetrachloride, titanium oxychloride or mixtures thereof. The foregoing starting materials can be made by well known techniques. The oxychlorides can be made by mixing the titanium tetrachloride with water. As known to those skilled in the art titanium tetrachloride dissolved in water forms a solution commonly referred to as titanium oxychloride.

It is believed that titanium compounds containing organic groups will work in the process of this disclosure, however, a titanium alkoxide was found to form mesoporous metal oxides having a pore volume and an average pore diameter lower than preferred.

A hydrous metal oxide intermediate forms, from the starting material for the metal oxide, in the presence of base or aqueous solvent, depending upon the reaction mechanism.

A base can be used to precipitate the hydrous metal oxide intermediate. A base can also serve as the source of cations for the porogen. Suitable bases for the practice of the disclosure can include, without limitation thereto, NH₄OH, (NH₄)₂CO₃, NH₄HCO₃, (CH₃)₄NOH, (CH₃CH₂)₄NOH, or other base or mixture of bases that are removable from the product of the disclosure by washing or calcining. NH₄OH is preferred.

In one embodiment of the disclosure, a solvent can be used in the process of this disclosure. A suitable solvent will depend upon the reaction mechanism, as discussed below. Solvents can be aqueous or organic, depending upon the titanium starting material. Suitable aqueous solvents include water (when additional salt is added as discussed below) or aqueous halide salt such as aqueous ammonium halide. Suitable organic solvents include lower alkyl group alcohols and dimethylacetamide. Lower alkyl group alcohols which have been found to be particularly useful in producing metal oxides of this disclosure typically have up to and including 3 carbon atoms. Specific examples of lower alkyl group alcohols include, without limitation, ethanol, isopropanol and n-propanol. A suitable solvent can also be the aqueous or organic solvent containing dissolved halide salt (e.g., ammonium halide), preferably a saturated solution of halide salt.

Solvents which have a low capacity to dissolve the porogen, such as aldehydes, ketones and amines, may also be suitable solvents. For example, without limitation thereto, in order for ammonium halide formed in situ to precipitate and act as a porogen, organic solvents having a low capacity to dissolve the ammonium halide or the saturated aqueous ammonium halide can be used.

Other examples of suitable solvents include, without limitation thereto, aqueous acid solutions, for example, a mineral acid solution. Examples of mineral acid solutions include, without limitation thereto, solutions of HCl, HBr or HF.

In general the suitability of a particular solvent or solvent system will depend upon the reactants, the porogen, the reaction mechanism and the desired porosity of the product.

The choice of solvent will depend upon the reaction mechanism and the porosity desired. When organic solvents are mixed with aqueous reagents, such as 50 wt % TiCl₄ in water and concentrated NH₄OH, the resulting organic-water liquid portion of the reaction mixture will dissolve more of the porogen than would be dissolved in the organic solvent alone. However, under the conditions of this disclosure, enough undissolved porogen must remain to ultimately produce a high-porosity metal-oxide product. A solvent in which the metal starting material is soluble is typically used.

In a specific embodiment, high porosity titanium dioxide can be obtained by using a high level of precipitated ammonium chloride, which acts as the porogen. This can be accomplished by performing the acid-base reaction in a solvent system having limited halide salt solubility thereby precipitating more than about 50 wt % of the halide salt, based on the total amount of the halide salt that can form from the reaction mixture, and especially for titanium tetrachloride, titanium oxychloride or mixtures thereof, precipitation of more than about 70 wt % being preferred, and precipitation of more than about 90 wt % being most preferred.

In a specific embodiment of the disclosure, it has been found that using solvents with low NH₄Cl solubility can yield TiO₂ having a high surface area, a pore volume of about 0.5 up to and including about 1.0 cc/g, and average pore diameter greater than about 300 Å.

A high water concentration in the reaction mixture will reduce pore volume by dissolving water soluble porogen, thereby leaving less precipitated porogen available for creating pores.

Water can be introduced to the process through the source of the metal or through the source of the base: for example, when the source of the metal is in an aqueous solution or when the base is in an aqueous solution.

It has been found that the solubility of ammonium halide in an organic-water mixture or in saturated aqueous ammonium halide, and the influence of ammonium halide solubility on the porosity of the metal oxide can be affected by the form of the metal starting material. For example, TiCl₄ can be introduced neat, or it can be mixed with water to make an aqueous solution which can be referred to as titanium oxychloride solution. For this titanium oxychloride solution, as the water:TiCl₄ weight ratio increases, ammonium halide solubility increases which will result in a decrease in product porosity. Similar results would be obtained for aqueous solutions of base as the water:base weight ratio increases.

Other solvent-specific factors can influence the pore volume of the metal oxide product; for example, different rates of precipitation of the porogen and the metal-oxide, and different rates of crystallization of the porogen and the metal oxide. These factors can impact the nature of the composite precipitate and the ability of the precipitated ammonium halide to produce the high porosity metal oxide product of this disclosure.

The concentration of the metal starting material can be in the range of about 0.01 M to about 5.0 M, preferably about 0.05 to about 0.5 M.

The titanium starting material may be in the form of a neat liquid or solid, or, preferably, as a solution in an aqueous or organic solvent.

There are several ways in which the hydrolyzed titanium compound and the porogen can be precipitated.

In one embodiment, a solvent is mixed with the titanium starting material to form a solution. The solvent-titanium-halide solution is mixed with a base to precipitate the titanium and the porogen. For example without limitation thereto, in the synthesis of TiO₂, titanium chloride as the neat liquid, or as an aqueous solution such as 50 wt. % TiCl₄ in water based on the entire weight of the solution may be mixed with the solvent. To the solvent-titanium-chloride solution so formed is added ammonium hydroxide to precipitate the hydrous compound containing titanium and the porogen, ammonium chloride.

In another embodiment of the disclosure, a solvent is first mixed with the base. The solvent-base mixture is contacted with the metal starting material to form a precipitate of the metal and the porogen. For example without limitation thereto, in the synthesis of TiO₂, NH₄OH may be contacted with the solvent to form the solvent-base solution or mixture which is then contacted with titanium chloride or titanium oxychloride to precipitate the hydrous compound containing titanium and the porogen, ammonium chloride.

The porogen is then removed to form the mesoporous metal oxide product of the disclosure which can be at least partially agglomerated. The agglomerated titanium oxide product can be dispersed by methods known to those skilled in the art to give titanium oxide nanoparticles.

If the porogen is removed by washing with water, a very high surface area, high porosity, mesoporous network of amorphous, hydrous titanium oxide remains. The amorphous, hydrous metal oxide can be a substantially amorphous hydrous titanium oxide that contains a minor proportion of crystalline titanium oxide.

If the porogen is removed by calcining, a high surface area, high porosity, mesoporous network of metal oxide nanocrystals remains.

In another embodiment of the disclosure a sufficient quantity of a halide salt can be added, after precipitating the hydrolyzed metal oxide, to saturate the liquid medium. A solid recovered from the saturated liquid medium comprises a hydrolyzed metal compound having pores containing the saturated liquid medium. The saturated liquid medium is removed from the solid to recover the mesoporous titanium oxide.

Typically, the liquid medium is the liquid portion of the mixture of solvent, with or without dissolved salt, and hydrous titanium oxide. As an example, without being limited thereto, a titanium starting material is contacted with water to form a solution. To the solution so formed is added a base to form a mixture comprising precipitated hydrous metal oxide and liquid medium. To that mixture is added halide salt to saturate the liquid medium. Thereafter, the mesoporous product is recovered by removing the saturated liquid medium. Typically, this is accomplished by drying to volatilize the liquid and calcining to remove the porogen which remains after drying.

In general, after contacting the starting materials, as described above, they can be mixed, preferably at room temperature, for less than one second up to several hours. Normally, mixing for 5-60 minutes will suffice. The precipitate can be recovered by any convenient method including settling, followed by decanting the supernatant liquid, filtration, centrifugation and so forth.

If a very high surface area hydrous titanium oxide is desired, the recovered solid, however collected, can be slurried with fresh water to remove the porogen, optionally, followed by additional washing steps. The hydrous metal oxide recovered by washing the solid to remove the porogen is substantially or completely amorphous, as determined by X-ray powder diffraction, and has a very high surface area, typically at least about 400 m²/g, typically in the range of about 400 to about 600 m²/g. The pore volume of the amorphous hydrous metal oxide can be at least about 0.4 cc/g, typically in the range of about 0.4 to about 1.0. The number of washing steps required to achieve the desired level of hydrous metal oxide purity will depend upon the solubility of the porogen, the amount of water employed, and the efficiency of the mixing process. The recovered solid can be dried by any convenient means including but not limited to radiative warming and oven heating. As an example, a very high surface area, mesoporous hydrous oxide of titanium having a surface area of at least 400 m²/g and pore volume of at least about 0.4 cc/g may be synthesized using the process of this disclosure.

If a high surface area, mesoporous, nanocrystalline, titanium oxide is desired, the hydrolyzed metal compound and porogen, however collected, can be calcined at a temperature that removes the porogen. Generally, the calcination temperatures are at least the sublimation or decomposition temperature of the porogen. Typically the calcination temperatures will range from about 300° C. to about 600° C., preferably between about 350° C. and about 550° C., and more preferably between about 400° C. and 500° C.

In the case of preparing TiO₂ from TiCl₄ and NH₄OH in saturated aqueous ammonium chloride, the 450° C.-calcined product can be composed of agglomerated nanocrystals of anatase, although some rutile, brookite, or X-ray amorphous material may also be present. The size of the anatase nanocrystals is a function of the calcination temperature and calcination time. At a calcination temperature of 450° C., the average crystallite size can be from about 10-15 nm.

The calcined TiO₂ made by the process of the disclosure is characterized by a combination of high surface area, high pore volume, and large average pore diameter. By high surface area is meant at least about 70 m²/g, typically, about 70 m²/g up to and including about 100 m²/g, high pore volume of at least about 0.5 cc/g, preferably at least about 0.6 cc/g, and large average pore diameter at least about 200 Å, preferably at least about 300 Å. Generally, the pore volume will range from about 0.5 cc/g to about 1.0 cc/g, and the average pore diameter from about 200 Å to about 500 Å.

For the titanium oxide, the porogen can be present in amounts sufficient to produce the mesoporous oxide of titanium having the pore volume and average pore diameter described in this disclosure. The amount of porogen sufficient to achieve the results of this disclosure can vary depending upon the porogen, the reaction conditions and the other ingredients (e.g. base, solvent and titanium-containing starting material). However, the concentration of ingredients and reaction conditions can provide for at least 2 moles of porogen to precipitate for each mole of hydrolyzed compound comprising titanium that precipitates. More specifically, for titanium tetrachloride or titanium oxychloride or mixtures thereof, the concentration of ingredients and reaction conditions can provide for at least 3 moles, even more specifically 4 moles, of porogen to precipitate for each mole of hydrolyzed compound comprising titanium that precipitates. While not wishing to be bound by any theory, a high porogen concentration can contribute to the formation of more pores (which can contribute to a high pore volume) and large pores which provide a high average pore diameter (which can contribute to a high pore volume).

The process of the disclosure may be performed in both batch and continuous modes. The solvent can be separated and recycled. The volatiles can be condensed, then recycled or disposed.

The pH of the system is generally in the range of about 4 to about 10, preferably from about 5 to about 9, and most preferably between about 6 and about 8. In a continuous process, the pH of the system is generally controlled better than with a batch process because it is believed that the material produced is exposed to less environmental variability in pH.

For a continuous mixing process, several process parameters may be varied in order to achieve high porosity. Such process parameters include, but are not limited to, the solvent used for each separate incoming stream, the flow rates, solution/slurry concentrations, and degree of mixing. In the continuous mixing process of this disclosure, good mixing is important. Good mixing can be achieved by combining separate solutions or slurries with fast flow rates through narrow diameter tubes, to provide turbulent, non laminar mixing which can be achieved using a T-shaped mixer. For example, for tubing having an inner diameter of about 0.19 inches, the total combined flow rate can be greater than about 500 mL/min., preferably greater than about 1000 mL/min., more preferably, greater than about 1500 mL/min. Without sufficient mixing, a high-porosity mesoporous material may not form. The slurry produced using the T-shaped mixer can be collected and further mixed with any convenient mixing device, such as an overhead stirrer.

The oxide of titanium further comprises a dopant which is samarium. A samarium-containing compound can be added with the titanium starting material. In one embodiment, the reaction mixture for making the titanium dioxide is formed by contacting the base and the solvent to form a solution or mixture and adding the titanium starting material and the source of samarium to the solution or mixture. In another embodiment, the reaction mixture is formed by contacting the titanium starting material, the source of samarium and the solvent to form a solution or mixture and adding the base to the solution or mixture.

Preferably the titanium starting material and the source of samarium are not added in succession, but added at the same time, or more preferably, the titanium starting material and source of samarium are mixed together before adding to the base-solvent solution or mixture.

Usually, a minor proportion of the samarium relative to the proportion of titanium and oxygen is suitable to meet the objectives of the disclosure. The mole ratio of titanium to samarium can range from about 1000 to about 1 to about 10 to about 1, typically about 200 to about 1 to about 20 to about 1. Examples of suitable sources of the samarium are selected from the group consisting of, but not limited to, SmCl₃, SmCl₃.6H₂O, Sm(O₂CCH₃)₃.2H₂O, Sm(NO₃)₃.6H₂O, and Sm₂(SO₄)₃.8H₂O and mixtures thereof.

Compositions of matter of this disclosure can be used as a luminescent material. Products, and methods of making them, that can contain luminescent titanium dioxide are well known to those skilled in the art and include plastic films and plastic articles, polymer fibers, pastes, coatings, including paints and the like. The crystal structure of the titanium dioxide of this disclosure can be substantially in the anatase form and can maintain an anatase crystal phase at temperatures over about 650° C. The samarium atoms as dopants in the crystal structure of the titanium dioxide can increase the temperature at which the titanium dioxide transitions from the anatase form to the rutile form. At temperatures of about 650° C., rutile is seen in the undoped anatase titanium dioxide. However, the samarium doped titanium dioxide can remain in the anatase form at temperatures as high as 950° C. and possibly higher. At 950° C. the titanium dioxide of this disclosure is predominantly in the rutile form with a minor proportion of anatase being observed. Below about 950° C. the titanium dioxide can be 100% anatase and even more typically it can be free of rutile and amorphous forms. The samarium-doped anatase titanium dioxide of this disclosure can have a minor amount of the brookite form of titanium dioxide after exposure to temperatures of about 450° C., the temperature employed in the process to remove volatiles. Typically the titanium dioxide can be substantially in the anatase form at temperatures below about 950° C.

It was found that after heating the anatase titanium dioxide product of this disclosure at 950° the X-ray powder diffraction pattern showed an amount of rutile which was estimated to be about 75% of the entire composition. Thus, the titanium dioxide product may be useful at temperatures below about 950° C. if a product free of rutile crystals is needed.

The impact of samarium doping on the anatase-to-rutile phase transition temperature indicates that the samarium is incorporated into the titanium dioxide structure and not simply located on the surface of the titanium dioxide particles.

The samarium-doped titanium dioxide of this disclosure can be luminescent upon exposure to light in the ultraviolet wavelength at room temperature (temperatures ranging from about 20 to about 25° C.). The samarium-doped titanium dioxide can luminesce orange-red.

In one embodiment, the disclosure herein can be construed as excluding any element or process step that does not materially affect the basic and novel characteristics of the composition or process. Additionally, the disclosure can be construed as excluding any element or process step not specified herein.

Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the disclosure be limited to the specific values recited when defining a range.

The examples which follow, description of illustrative and preferred embodiments of the present disclosure are not intended to limit the scope of the disclosure. Various modifications, alternative constructions and equivalents may be employed without departing from the true spirit and scope of the appended claims.

### Test Methods

The following test methods and procedures were used in the Examples below:

Nitrogen Porosimetry: Dinitrogen adsorption/desorption measurements were performed at 77.3 K on Micromeritics ASAP model 2400/2405 porosimeters (Micromeritics Inc., One Micromeritics Drive, Norcross Ga. 30093-1877). Samples were degassed at 150° C. overnight prior to data collection. Surface area measurements utilized a five-point adsorption isotherm collected over 0.05 to 0.20 p/p₀ and analyzed via the BET method (described in S. Brunauer, P. H. Emmett and E. Teller, J. Amer. Chem. Soc., 60, 309 (1938)). Pore volume distributions utilized a 27 point desorption isotherm and were analyzed via the BJH method (described in E. P. Barret, L. G. Joyner and P. P. Halenda, J. Amer. Chem. Soc., 73, 373 (1951)). Values for pore volume represent the single point total pore volume of pores less than about 3000 angstroms. Average pore diameter, D, is determined by D=4V/A, where V is the single point total pore volume and A is the BET surface area.

X-ray Powder Diffraction: Room-temperature powder x-ray diffraction data were obtained with a Philips X'PERT automated powder diffractometer, Model 3040. Samples were run in batch mode with a Model PW 1775 or Model PW 3065 multi-position sample changer. The diffractometer was equipped with an automatic variable slit, a xenon proportional counter, and a graphite monochromator. The radiation was CuK(alpha) (45 kV, 40 mA). Data were collected from 2 to 60 degrees 2-theta; a continuous scan with an equivalent step size of 0.03 deg; and a count time of 0.5 seconds per step.

Thermogravimetric Analysis: About 5-20 mg samples were loaded into platinum TGA pans. Samples were heated in a TA Instruments 2950 TGA under 60 ml/min air purge and 40 ml/min N₂ in the balance area (total purge rate was 100 ml/min). Samples were heated from RT to 800° C. at 10° C./min. The temperature scale of the TGA was previously calibrated at the 10° C./min rate using thermomagnetic standards.

Ionic Conductivity: Ionic conductivity was measured with a VWR traceable conductivity/resistivity/salinity concentration meter. The ionic conductivity of the wash solutions was used to determine when the majority of the NH₄Cl salt had been removed.

Particle Size Distribution (PSD): Particle size distribution was measured with a Malvern Nanosizer Dynamic Light Scattering Unit on suspensions containing 0.1 wt % TiO₂.

Index of Refraction: The index of refraction of samples was measured with a Metricon Prism Coupler, Model 2010, with four wavelengths available (633, 980, 1310 and 1550 nm). This instrument interprets the amount of light coupled into a sample that is pressed into contact with a high index prism. The light enters the sample from the prism side and the angle of incidence is varied. The wavelength selected in the examples below was 1550 nm. The sample was placed against the prism and held in close optical contact with the prism by a pneumatic ram. The sample surface was flat, smooth and clean, and of uniform thickness. The aligned laser light hit the optically contacted spot between the sample and the prism, and the index of refraction was obtained from a plot of intensity versus angle of incidence.

Photo Voltaic Power Efficiency: Photo voltaic power efficiency (“PVPE”) was measured using photoelectrochemical techniques as described in section 2.5 of M. K. Nazeeruddin, et al., J. Am. Chem. Soc., Vol. 123, pp. 1613-1624, 2001. Data were obtained by using a 450 W xenon light source that was focused to give 1000 W/m², at the surface of the test cell, and measuring the output with a digital source meter. The information was analyzed after data acquisition.

Luminescence Spectra: Samples were pressed as powder onto black nonluminescent tape. Spectra were acquired 90° to exciting source with sample at ˜45° to the exciting line. Low pass cutoff filters used: Corning 3-75, 3-70, and 3-69. Instrument: SPEX Fluorolog 322 with 300 nm/500 nm blazed gratings. Detector: Hammatsu red enhanced photomultiplier tube. Slits: 1 nm excitation, 1 nm emission. Acquisition: 5 sec/pt, 0.5 nm/pt.

### EXAMPLES

In the following Examples and Comparative Examples, reaction products of a Group IVB metals were formed and characterized. Surface area and porosity data are summarized in Table 6 and were obtained by the procedures described above.

All chemicals and reagents were used as received from:

| | |
|---|---|
| TiCl₄ | Aldrich Chemical Co., Milwaukee, WI, 99.9% |
| ZrOCl₂•8H₂O | Alfa Aesar, Ward Hill, MA, 99.9% |
| HfOCl₂•8H₂O | Alfa Aesar, Ward Hill, MA, 99.98% |
| ethanol | Pharmco, Brookfield, CT, ACS/USP Grade 200 Proof |
| NH₄OH | EMD Chemicals, Gibbstown, NJ, 28.0-30.0% |
| NH₄Cl | EMD Chemicals, Gibbstown, NJ, 99.5% |
| n-propanol | EMD Chemicals, Gibbstown, NJ, 99.99% |
| isopropanol | EMD Chemicals, Gibbstown, NJ, 99.5% |
| n-butanol | EMD Chemicals, Gibbstown, NJ, 99.97% |
| iso-butanol | EMD Chemicals, Gibbstown, NJ, 99.0% |
| tert-butanol | EMD Chemicals, Gibbstown, NJ, 99.0% |
| DMAc | EMD Chemicals, Gibbstown, NJ, 99.9% (N,N′ |
| | dimethylacetamide) |
| acetone | EMD Chemicals, Gibbstown, NJ, 99.5% |
| | (reagent bottle) |
| TiO₂ | Degussa Inc., Parsipanny, NJ, P25 |
| TSPP | tetrasodiumpyrophosphate (CAS number 7722-88-5) |
| Tetraethyl- | Aldrich Chemical Co., Milwaukee, WI, 98% |
| orthosilicate | |
| AlCl₃•6H₂O | J. T. Baker, Phillipsburg, NJ, 98.7%. |
| SmCl3•6H2O | |

All references herein to elements of the Periodic Table of the Elements are to the CAS version of the Periodic Table of the Elements.

In Comparative Examples A, B, C, D, and in Examples 1-5, 7-9 and 11, the amount of 50 wt. % TiCl₄ in water is the source of titanium oxychloride.

### Comparative Example A

This example illustrates that reaction of titanium oxychloride and NH₄OH in water alone does not produce a TiO₂ product, uncalcined or calcined, having the surface area and porosity properties of TiO₂ made by processes of this disclosure. The precipitate formed from the reaction of titanium oxychloride and NH₄OH in water is washed extensively to remove any trapped NH₄Cl byproduct.

20.0 g (14 mL) of 50 wt. % TiCl₄ in water were added to about 200 mL deionized water while stirring with a Teflon coated magnetic stirring bar in a 400 mL Pyrex beaker. With stirring, 14.5 mL concentrated NH₄OH (i.e., ˜30% wt=14.8 M) were added to the titanium solution. The pH of the slurry, measured with multi-color strip pH paper, was about 7. The resulting slurry was stirred for 60 minutes at ambient temperature.

The solid was washed extensively with deionized water until the clear, colorless supernatant wash water had a low ionic conductivity value, 12 μS/cm. The solid was collected by suction filtration and dried under an IR heat lamp. An X-ray powder diffraction pattern showed the material to be amorphous. Nitrogen porosimetry measurements of this uncalcined powder revealed a surface area of 398 m²/g, a pore volume of 0.37 cc/g, and an average pore diameter of 37 Å.

The powder was transferred to an alumina crucible and heated uncovered from room temperature to 450° C. over the period of one hour, and held at 450° C. for an additional hour. The crucible and its contents were removed from the furnace and cooled naturally to room temperature.

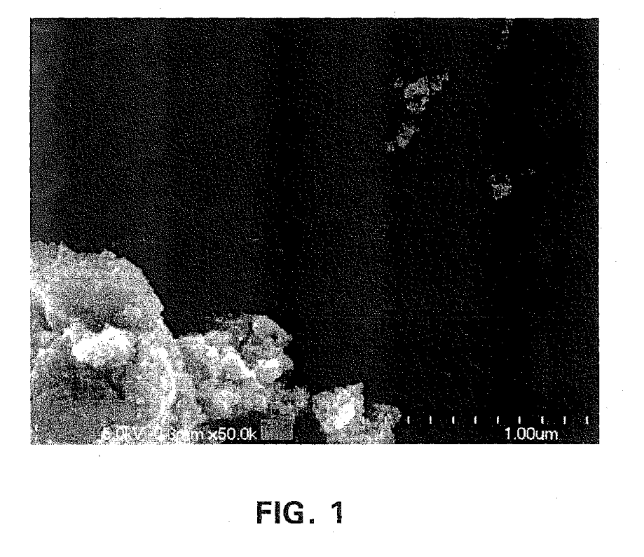

An X-ray powder diffraction pattern of the calcined material showed only the broad lines of anatase indicating an average crystal size of 16 nm. Nitrogen porosimetry revealed a surface area of 72 m²/g, a pore volume of 0.17 cc/g, and an average pore diameter of 95 Å. FIG. 1 is a scanning electron microscope (SEM) image of the calcined powder, at a magnification of 50,000×, showing the product is compacted with low porosity. The porosimetry data of this Example are reported in Table 6.

### Comparative Example B

This example also illustrates that reaction of titanium oxychloride and NH₄OH in water alone does not produce a TiO₂ product, uncalcined or calcined, having the surface area and porosity properties of a TiO₂ product of this disclosure. Here, the precipitate formed from the reaction of titanium oxychloride and NH₄OH in water is collected and processed without the washing step used in Comparative Example A to remove NH₄Cl byproduct.

20.0 g (14 mL) of 50 wt. % TiCl₄ in water were added to about 200 mL deionized water while stirring with a Teflon coated magnetic stirring bar in a 400 mL Pyrex beaker. With stirring, 28 mL 1:1 NH₄OH (i.e., 14-15% wt=7.5 M) were added to the titanium solution. The pH of the slurry, measured with multi-color strip pH paper, was about 5. The resulting slurry was stirred for 60 minutes at ambient temperature.

The unwashed solid was collected by suction filtration and dried under an IR heat lamp. An X-ray powder diffraction pattern showed the lines of NH₄Cl and a trace of anatase. Nitrogen porosimetry measurements of this mixture revealed a surface area of 215 m²/g, a pore volume of 0.17 cc/g, and an average pore diameter of 31 Å.

The powder was transferred to an alumina crucible and heated uncovered from room temperature to 450° C. over the period of one hour, and held at 450° C. for an additional hour. The crucible and its contents were removed from the furnace and cooled naturally to room temperature.

An X-ray powder diffraction pattern of the calcined material showed broad lines of anatase as the most intense and also showed one line of brookite with very low intensity. Nitrogen porosimetry revealed a surface area of 70 m²/g, a pore volume of 0.25 cc/g, and an average pore diameter of 146 Å. The porosimetry data of this Example are reported in Table 6.

### Comparative Example C

This example illustrates that reaction of titanium oxychloride and NH₄OH using acetone as the solvent does not result in a calcined TiO₂ having the surface area and porosity properties of a calcined TiO₂ product made by the process of this disclosure.

20.0 g (14 mL) of 50 wt. % TiCl₄ in water were added to about 200 mL acetone while stirring with a Teflon coated magnetic stirring bar in a 400 mL Pyrex beaker. With stirring, 28 mL 1:1 NH₄OH (i.e., 14-15% wt=7.5 M) were added to the titanium solution. The pH of the slurry, measured with water moistened multi-color strip pH paper, was about 7. The resulting slurry was stirred for 60 minutes at ambient temperature.

The solid was collected by suction filtration and dried under an IR heat lamp to yield 14.5 g of white powder. An X-ray powder diffraction pattern showed only the lines of NH₄Cl.

The powder was transferred to an alumina crucible and heated uncovered from room temperature to 450° C. over the period of one hour, and held at 450° C. for an additional hour. The crucible and its contents were removed from the furnace and cooled naturally to room temperature. It was observed that the volume of powder after calcination was about half the volume of the starting precalcined powder.

An X-ray powder diffraction pattern of the calcined material showed broad lines of anatase as the most intense, and also showed some lines of rutile with very low intensity, as well as some amorphous material. Nitrogen porosimetry revealed a surface area of 75.8 m²/g, a pore volume of 0.24 cc/g, and an average pore diameter of 129 Å. The porosimetry data of this Example are reported in Table 6.

### Comparative Example D

This example describes that reaction of titanium oxychloride and NH₄OH in the three butanol isomers to form TiO₂.

20.0 g (14 mL) of 50 wt. % TiCl₄ in water were added to about 200 mL n-butanol, tert-butyl alcohol, and isobutyl alcohol, respectively, while stirring with a Teflon coated magnetic stirring bar in 400 mL Pyrex beakers. With stirring, 29 mL 1:1 NH₄OH (i.e., 14-15% wt=7.5 M) were added to each of the three titanium solutions. The pH of the slurries was measured with water moistened multi-color strip pH paper and observed to be in the range of ˜6-7. The slurries were stirred for 60 minutes at ambient temperature.

The solids were each collected by suction filtration and dried under an IR heat lamp to give yields of 14.7 g, 13.3 g, and 13.1 g, respectively. X-ray powder diffraction patterns showed only the lines of NH₄Cl for the n-butanol and tert-butyl alcohol reactions, and a trace of anatase in addition to NH₄Cl for the isobutyl alcohol reaction.

The powders were transferred to alumina crucibles and heated, uncovered, from room temperature to 450° C. over the period of one hour, and held at 450° C. for an additional hour. The crucibles and their contents were removed from the furnace and cooled naturally to room temperature. X-ray powder diffraction patterns of the calcined materials showed the crystalline phases reported in Table 1:

TABLE 1

| Butanol | Crystalline phases determined by |
|---|---|
| solvent | XPD |
| n-butanol | anatase, trace of brookite |
| tert-butyl alcohol | anatase |
| isobutyl alcohol | anatase, NH₄Cl, small amount of rutile |

Nitrogen porosimetry revealed the following surface areas, pore volumes, and average pore diameters reported in Table 2:

TABLE 2

| | surface area | pore | ave. pore diam. |
|---|---|---|---|
| | (m²/g) | vol. (cc/g) | (Å) |
| (I) n-butanol | 82 | 0.4 | 193 |
| (II) tert-butyl | 74 | 0.37 | 202 |
| alcohol | | | |
| (III) isobutyl | 109 | 0.28 | 105 |
| alcohol | | | |

As shown in Table 2, the TiO₂ product formed in accordance with the procedure of this Comparative Example D, wherein the solvent was each of the three different butanol isomers, did not have the porosity properties of TiO₂ produced by the process of this disclosure. The porosimetry data of this Example are also reported in Table 6.

### Example 1

This example illustrates that reaction of titanium oxychloride and NH₄OH in aqueous saturated NH₄Cl can produce a calcined mesoporous nanocrystalline TiO₂ powder having a high surface area and high porosity.

20.0 g (14 mL) of 50 wt. % TiCl₄ in water were added to about 250 mL aqueous NH₄Cl solution, made by dissolving 73 g NH₄Cl in 200 g deionized H₂O, with stirring with a Teflon coated magnetic stirring bar in a 400 mL Pyrex beaker. With continued stirring, 30 mL 1:1 NH₄OH (i.e., 14-15 wt % or 7.5 M) were added to the titanium-chloride/ammonium chloride solution. The pH of the slurry, measured with multi-color strip pH paper, was about 7. The resulting slurry was stirred for 60 minutes at ambient temperature.

The solid was collected by suction filtration and dried under an IR heat lamp to yield 14.9 g of white powder. The powder was then transferred to an alumina crucible and heated uncovered from room temperature to 450° C. over the period of one hour, and held at 450° C. for an additional hour to ensure removal of the volatile NH₄Cl. The crucible and its contents were removed from the furnace and cooled naturally to room temperature.

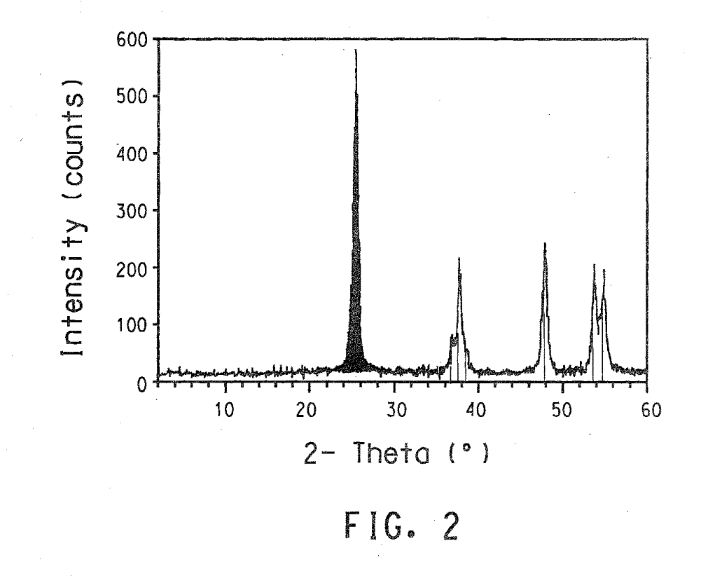

An X-ray powder diffraction pattern of the calcined material showed only broad lines of anatase and from the width of the strongest peak an average crystal size of 12 nm was estimated (see FIG. 2). Nitrogen porosimetry revealed a surface area of 88 m²/g, a pore volume of 0.72 cc/g, and an average pore diameter of 325 Å. The porosimetry data of this Example are reported in Table 6.

### Example 2

This example illustrates that reaction of titanium oxychloride and NH₄OH in absolute ethanol can produce a calcined mesoporous nanocrystalline TiO₂ powder having a high surface area and high porosity.

15 mL concentrated NH₄OH were added to about 200 mL absolute ethanol while stirring with a Teflon coated magnetic stirring bar in a 400 mL Pyrex beaker. With stirring, 20.0 g (14 mL) of 50 wt. % TiCl₄ in water were added to the basic solution. The pH of the slurry, measured with water moistened multi-color strip pH paper, was about 8. The resulting slurry was stirred for 60 minutes at ambient temperature.

The solid was collected by suction filtration and dried under an IR heat lamp. The powder was transferred to an alumina boat and heated uncovered from room temperature to 450° C. over the period of one hour, and held at 450° C. for an additional hour. The furnace with the boat and its contents were cooled naturally to room temperature. An X-ray powder diffraction pattern of the calcined material showed only the broad lines of anatase. Nitrogen porosimetry revealed a surface area of 84 m²/g, a pore volume of 0.78 cc/g, and an average pore diameter of 371 Å. The porosimetry data of this Example are reported in Table 6.

### Example 3

This example illustrates that adding NH₄OH to a solution of titanium oxychloride in n-propanol can produce a calcined mesoporous nanocrystalline TiO₂ powder having a high surface area and high porosity.

20.0 g (14 mL) of 50 wt. % TiCl₄ in water were added to about 200 mL n-propanol while stirring with a Teflon coated magnetic stirring bar in a 400 mL Pyrex beaker. With stirring, 28 mL 1:1 NH₄OH (i.e., 14-15% wt or 7.5 M) were added to the titanium solution. The pH of the slurry, measured with water moistened multi-color strip pH paper, was about 6. The resulting slurry was stirred for 60 minutes at ambient temperature.

The solid was collected by suction filtration and dried under an IR heat lamp to yield 13.0 g of white powder. An X-ray powder diffraction pattern showed only the lines of NH₄Cl. The powder was transferred to an alumina crucible and heated uncovered from room temperature to 450° C. over the period of one hour, and held at 450° C. for an additional hour to ensure removal of the volatile NH₄Cl. The crucible and its contents were removed from the furnace and cooled naturally to room temperature. Surprisingly, the volume of powder after calcination was almost the same as that of the starting pre-calcined powder, even though the amount of NH₄Cl in the starting mixture was ˜65% by weight.

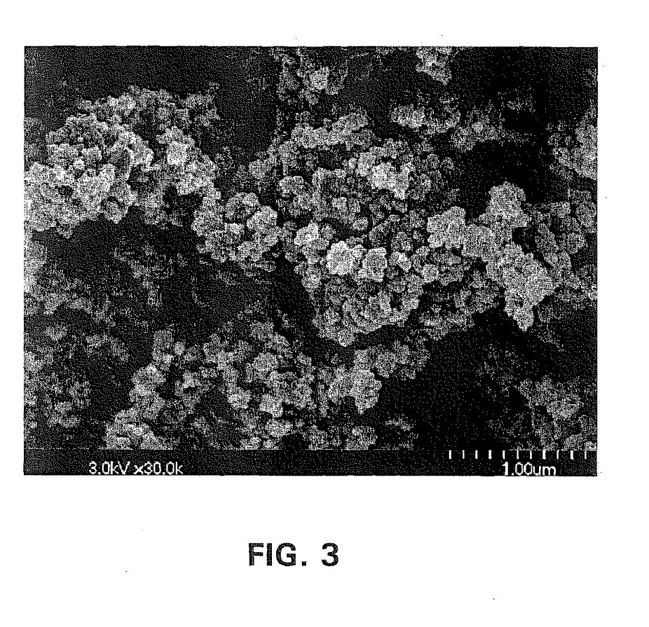

Nitrogen porosimetry revealed a surface area of 89 m²/g, a pore volume of 0.65 cc/g, and an average pore diameter of 293 Å. A Scanning Electron Microscopy image at 30,000× magnification, FIG. 3, shows porous agglomerates of TiO₂ crystals. The porosimetry data of this Example are reported in Table 6.

### Example 4

This example illustrates that adding titanium oxychloride to a solution of NH₄OH in n-propanol can produce a calcined mesoporous nanocrystalline TiO₂ powder having a high surface area and high porosity.

37.5 mL concentrated NH₄OH were added to about 500 mL n-propanol while stirring with a Teflon coated magnetic stirring bar in a 1 L Pyrex beaker. With continued stirring, 35 mL of 50 wt. % TiCl₄ in water were added to the NH₄OH-propanol solution. The resulting slurry with pH 7 was stirred for 60 minutes at ambient temperature.

The solid was collected by suction filtration and dried under an IR heat lamp. The voluminous powder was transferred to alumina boats and heated uncovered, under flowing air in a tube furnace, from room temperature to about 450° C. over the period of one hour, and held at about 450° C. for an additional hour to ensure removal of the volatile NH₄Cl. The furnace was allowed to cool naturally to room temperature, and the fired material was recovered.

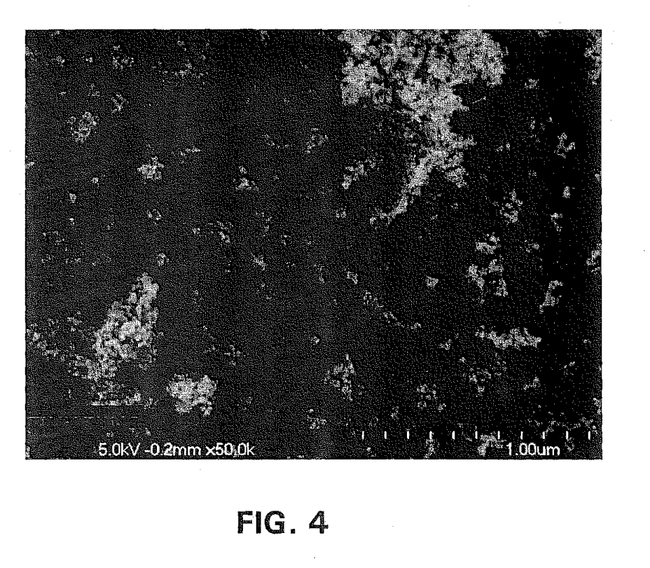

An X-ray powder diffraction pattern of the calcined material showed the broad lines of anatase and a trace of rutile. Nitrogen porosimetry revealed a surface area of 86 m²/g, a pore volume of 0.93 cc/g, and an average pore diameter of 435 Å. FIG. 4 is a Scanning Electron Microscopy image of the product of this Example at 50,000× magnification showing very porous agglomerates of TiO₂ crystals. The porosimetry data of this Example are reported in Table 6.

### Example 5

This example, where NH₄OH is added to a solution of titanium oxychloride in n-propanol in the presence of a surfactant, describes a calcined mesoporous nanocrystalline TiO₂ powder having a high surface area and high porosity.

20.0 g (14 mL) of 50 wt. % TiCl₄ in water were added to about 200 mL of 5% wt Pluronic P123 (BASF Corp) surfactant in n-propanol while stirring with a Teflon coated magnetic stirring bar in a 400 mL Pyrex beaker. With stirring, 29 mL 1:1 NH₄OH (i.e., 14-15% wt or 7.5 M) were added to the titanium solution. The resulting slurry was stirred for 60 minutes at ambient temperature.

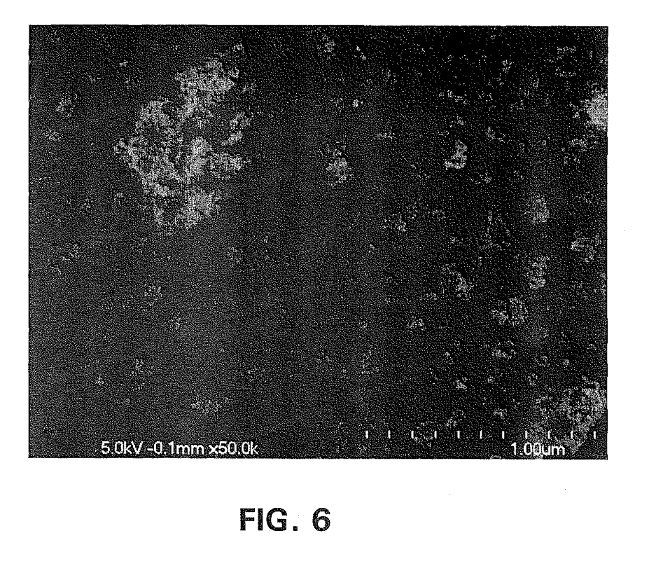

The solid was collected by suction filtration and dried under an IR heat lamp to yield 14.1 g of white powder. The powder was transferred to an alumina crucible and heated uncovered from room temperature to 450° C. over the period of one hour, and held at 450° C. for an additional hour to ensure removal of the volatile NH₄Cl template. The crucible and its contents were removed from the furnace and cooled naturally to room temperature. An X-ray powder diffraction pattern of the calcined material showed broad lines of anatase (14 nm average crystal size), and a very small amount of rutile. Nitrogen porosimetry revealed a surface area of 91 m²/g, a pore volume of 0.63 cc/g, and an average pore diameter of 276 Å. FIGS. 5 and 6 are scanning electron microscopy images with magnifications of 25,000× and 50,000×, respectively, showing very porous agglomerates of TiO₂ particles. The porosimetry data of this Example are reported in Table 6.

### Example 6

This example illustrates that starting with neat TiCl₄ and concentrated aqueous NH₄OH in n-propanol results in a calcined mesoporous nanocrystalline TiO₂ powder having a high surface area and high porosity.

10 g of 99.995 TiCl₄ were added to about 200 mL n-propanol while stirring with a Teflon coated magnetic stirring bar in a 400 mL Pyrex beaker. With stirring, 16 mL concentrated NH₄OH were added to the titanium solution. The thick slurry was thinned with an additional small portion of n-propanol. The pH of the slurry, measured with water moistened multi-color strip pH paper, was about 7-8. The resulting slurry was stirred for 60 minutes at ambient temperature.

The solid was collected by suction filtration and dried under an IR heat lamp to yield 16.1 g of white powder. An X-ray powder diffraction pattern showed only the lines of NH₄Cl. A TGA of this mixture exhibited a total weight loss of 74% up to ˜300° C. indicating that most of the NH₄Cl had been precipitated along with the TiO₂.

The powder was transferred to an alumina crucible and heated uncovered from room temperature to 450° C. over the period of one hour, and held at 450° C. for an additional hour to ensure removal of the volatile NH₄Cl. The crucible and its contents were removed from the furnace and cooled naturally to room temperature. An X-ray powder diffraction pattern of the calcined material showed broad lines of anatase, a very small amount of brookite, and some amorphous material. Nitrogen porosimetry revealed a surface area of 89 m²/g, a pore volume of 0.56 cc/g, and an average pore diameter of 251 Å. The porosimetry data of this Example are reported in Table 6.

### Example 7

This example illustrates that adding NH₄OH to a solution of titanium oxychloride in isopropanol results in a calcined mesoporous nanocrystalline TiO₂ powder having a high surface area and high porosity.

20.0 g (14 mL) of 50 wt. % TiCl₄ in water were added to about 200 mL isopropanol while stirring with a Teflon coated magnetic stirring bar in a 400 mL Pyrex beaker. With stirring, 30 mL 1:1 NH₄OH (i.e., 14-15% wt or 7.5 M) were added to the titanium solution. The resulting slurry was stirred for 60 minutes at ambient temperature.

The solid was collected by suction filtration and dried under an IR heat lamp. An X-ray powder diffraction pattern showed only the lines of NH₄Cl.

The powder was transferred to an alumina crucible and heated uncovered from room temperature to 450° C. over the period of one hour, and held at 450° C. for an additional hour to ensure removal of the volatile NH₄Cl. The crucible and its contents were removed from the furnace and cooled naturally to room temperature.

An X-ray powder diffraction pattern of the calcined material showed only broad lines of anatase and some amorphous material. The average crystallite size of the anatase was estimated to be 11 nm from X-ray peak broadening analysis. Nitrogen porosimetry revealed a surface area of 78 m²/g, a pore volume of 0.74 cc/g, and an average pore diameter of 378 Å. The porosimetry data of this Example are reported in Table 6.

### Example 8

This example illustrates that adding NH₄OH to a solution of titanium oxychloride in N,N′ dimethylacetamide (DMAC) resulted in a calcined mesoporous nanocrystalline TiO₂ powder having a high surface area and high porosity.

20.0 g (14 mL) of 50 wt. % TiCl₄ in water were added to about 200 mL N,N′ dimethylacetamide (DMAC) while stirring with a Teflon coated magnetic stirring bar in a 400 mL Pyrex beaker. With stirring, 29 mL 1:1 NH₄OH were added to the titanium solution. The resulting slurry was stirred for 60 minutes at ambient temperature.

The solid was collected by suction filtration and dried under an IR heat lamp. The powder was transferred to an alumina crucible and heated uncovered from room temperature to 450° C. over the period of one hour, and held at 450° C. for an additional hour to ensure removal of the volatile NH₄Cl porogen. The crucible and its contents were removed from the furnace and cooled naturally to room temperature. An X-ray powder diffraction pattern of the calcined material showed only broad lines of anatase with an average crystallite size of 13 nm. Nitrogen porosimetry revealed a surface area of 88 m²/g, a pore volume of 0.68 cc/g, and an average pore diameter of 313 Å. The porosimetry data of this Example are reported in Table 6.

### Example 9

This example illustrates that addition of NH₄Cl to the aqueous slurry formed by reaction of NH₄OH with titanium oxychloride results in a calcined mesoporous nanocrystalline TiO₂ powder having a high surface area and high porosity.

20.0 g (14 mL) of 50 wt. % TiCl₄ in water were added to about 200 mL deionized H₂O while stirring with a Teflon coated magnetic stirring bar in a 400 mL Pyrex beaker. With stirring, 29 mL 1:1 NH₄OH (i.e., 14-15% wt or 7.5 M) were added to the titanium solution. The pH of the slurry was about 8. After a few minutes, 89 g NH₄Cl were added to the slurry, and the mixture was stirred for 60 minutes at ambient temperature.

The solid was collected by suction filtration and dried under an IR heat lamp. An X-ray powder diffraction pattern showed only the lines of NH₄Cl. The powder was transferred to an alumina crucible and heated uncovered from room temperature to about 450° C. over the period of one hour, and held at about 450° C. for an additional hour to ensure removal of the volatile NH₄Cl. The crucible and its contents were removed from the furnace and cooled naturally to room temperature.

An X-ray powder diffraction pattern of the calcined material showed the broad lines of anatase and a very small amount of brookite. Nitrogen porosimetry revealed a surface area of 80 m²/g, a pore volume of 0.52 cc/g, and an average pore diameter of 260 Å. The porosimetry data of this Example are reported in Table 6.

### Example 10

This example illustrates that adding NH₄OH to a solution of TiCl₄ in n-propanol resulted in a washed and dried, uncalcined, mesoporous, TiO₂ powder having a very high surface area and high porosity.

12.5 g TiCl₄ were added to about 200 mL n-propanol while stirring with a Teflon coated magnetic stirring bar in a 400 mL Pyrex beaker. With stirring, 19 mL concentrated NH₄OH were added to the titanium solution. The resulting slurry was stirred for 60 minutes at ambient temperature.

The solid was collected by suction filtration and dried under an IR heat lamp. The mixture was slurried in 1 L deionized water, stirred for 15 minutes, and collected by suction filtration. The latter step was repeated, but this time stirring of the slurry was extended to 90 minutes. After overnight drying at room temperature, a voluminous 7.7 g of powder was recovered. An X-ray powder diffraction pattern showed the washed TiO₂ to be amorphous. Nitrogen porosimetry measurements on this mixture revealed a surface area of 511 m²/g, a pore volume of 0.86 cc/g, and an average pore diameter of 68 Å. The porosimetry data of this Example are reported in Table 6.

### Comparative Example E

This example shows that calcination of the washed and dried TiO₂ product of Example 10, which no longer contains sufficient NH₄Cl porogen, does not give a nanocrystalline TiO₂ powder having the high surface area and high porosity of TiO₂ made by processes of this disclosure.

The washed and dried powder in Example 10 was transferred to an alumina crucible and heated uncovered from room temperature to 450° C. over the period of one hour, and held at 450° C. for an additional hour to ensure removal of the volatile NH₄Cl. The crucible and its contents were removed from the furnace and cooled naturally to room temperature. X-ray powder diffraction of the calcined material showed only broad lines of anatase and some amorphous material. Nitrogen porosimetry revealed a surface area of 61 m²/g, a pore volume of 0.34 cc/g, and an average pore diameter of 223 Å. The porosimetry data of this Example are reported in Table 6.

### Example 11

This example, where NH₄OH is added to a solution of titanium oxychloride in n-propanol in the presence of a surfactant, describes a washed and dried, uncalcined mesoporous TiO₂ powder having a very high surface area and high porosity.

Example 5 was repeated, but rather than drying and calcining, the filtered, undried product cake was slurried with 1 L deionized water, stirred for 75 minutes, and collected by suction filtration. This washing step was repeated two more times. The filtered white powder was dried under an IR heat lamp. An X-ray powder diffraction pattern showed the washed and dried product to be amorphous. Nitrogen porosimetry revealed a surface area of 526 m²/g, a pore volume of 0.47 cc/g, and an average pore diameter of 35 Å. The porosimetry data of this Example are reported in Table 6.

### Example 12

This example demonstrates the utility of the mesoporous, titanium dioxide product as a nanoparticle precursor. Micron size TiO₂ particles are deagglomerated by a factor of 100-500, e.g., particles having a d₅₀˜50 μm are reduced in size to have d₅₀˜0.100 μm (100 nm).

TiO₂ powders from Examples 1, 4, and 5 above were dispersed by shaking in water containing 0.1 wt % TSPP surfactant. The particle size distributions for these powders before and after 20 minutes of sonication are shown in Table 3.

TABLE 3

| | d₅₀ (μm) | d₅₀ (μm) after 20 min. |
|---|---|---|
| TiO₂ powder | as prepared | sonication |
| Example 1 | 46.7 | 0.088 |
| Example 4 | 11.3 | 0.110 |
| Example 5 | 23.7 | 0.130 |

### Example 13

This example demonstrates the utility of the nanocrystalline, mesoporous titanium dioxide in a photovoltaic device. TiO₂ powder made as described in Example 3, was blended with a binder and cast into a film on an electrically-conducting fluorine-doped tin-oxide (FTO) coated glass substrate. This anode was assembled into a dye-sensitized solar cell and tested as described in section 2.5 of “Engineering of Efficient Panchromatic Sensitizers for Nanocrystalline TiO₂-Based Solar Cells”, M. K. Nazeeruddin, et al., J. Am. Chem. Soc., volume 123, pp. 1613-1624, 2001. A control experiment using Degussa P25 TiO₂ was used for comparison. The cell containing TiO₂ of this disclosure exhibited a higher power conversion efficiency, relative to that of the control cell. The results are reported in Table 4.

TABLE 4

| | Relative power conversion |
|---|---|
| TiO₂ film | efficiency |
| Example 3 | 1.13 |
| Degussa | 1.00 |
| P25 | |

### Example 14

This example demonstrates the utility of the nanocrystalline, mesoporous titanium dioxide in an optical device. The index of refraction of a polymethylmethacrylate (PMMA) polymer film was modified by blending the PMMA polymer with TiO₂ powder from Example 4 to make composite films containing 5% wt TiO₂. The results are reported in Table 5.

TABLE 5

| Film | index of refraction at 1550 nm |
|---|---|
| PMMA (two sample films) | 1.479, 1.479 |
| PMMA + TiO₂ from Example 4 | 1.512, 1.514 |
| (two composite sample films) | |

### Comparative Example F

This example shows that reaction of ZrOCl₂.8H₂O with NH₄OH in water does not result in calcined ZrO₂ as obtained via aqueous saturated NH₄Cl solution.

11.0 g ZrOCl₂.8H₂O were dissolved in 100 mL deionized H₂O while stirring with a Teflon coated magnetic stirring bar in a 250 mL Pyrex beaker. With stirring, 10 mL concentrated NH₄OH were added to the zirconium solution. The pH of the slurry, measured with multi-color strip pH paper, was about 10. The resulting slurry was stirred for 60 minutes at ambient temperature.

The solid was collected by suction filtration and dried under an IR heat lamp. The powder was transferred to an alumina crucible and heated uncovered from room temperature to 450° C. over the period of one hour, and held at 450° C. for an additional hour. The crucible and its contents were removed from the furnace and cooled naturally to room temperature.

An X-ray powder diffraction pattern of the calcined material showed a mixture of the monoclinic and tetragonal forms of ZrO₂ with the crystallites ranging 11-16 nm in size. Nitrogen porosimetry revealed a surface area of 63.4 m²/g, a pore volume of 0.13 cc/g, and an average pore diameter of 84 Å. The porosimetry data of this Example are reported in Table 6.

### Example 15

This example, using ZrOCl₂.8H₂O in aqueous saturated NH₄Cl solution, illustrates the synthesis of calcined ZrO₂ product in accordance with this disclosure.

11.0 g ZrOCl₂.8H₂O were dissolved in 100 mL aqueous NH₄Cl solution saturated at room temperature, while stirring with a Teflon coated magnetic stirring bar in a 250 mL Pyrex beaker. With stirring, 20 mL 1:1 NH₄OH:H₂O were added to the zirconium solution. The pH of the slurry, measured with multi-color strip pH paper, was about 10. The resulting slurry was stirred for 60 minutes at ambient temperature.

The solid was collected by suction filtration and dried under an IR heat lamp. The powder was transferred to an alumina crucible and heated uncovered from room temperature to 450° C. over the period of one hour, and held at 450° C. for an additional hour. The crucible and its contents were removed from the furnace and cooled naturally to room temperature.

An X-ray powder diffraction pattern of the calcined material showed only the tetragonal form of ZrO₂ with 7 nm crystals. Nitrogen porosimetry revealed a surface area of 84 m²/g, a pore volume of 0.31 cc/g, and an average pore diameter of 146 Å. The porosimetry data of this Example are reported in Table 6.

### Example 16

This example, using ZrOCl₂.8H₂O illustrates the synthesis of calcined product via addition of NH₄Cl after forming the ZrO₂ precipitate.

11.0 g ZrOCl₂.8H₂O were dissolved in 100 mL deionized H2O at room temperature while stirring with a Teflon coated magnetic stirring bar in a 250 mL Pyrex beaker. With stirring, 10 mL concentrated NH₄OH were added to the zirconium solution. After a few minutes, 45 g NH₄Cl were added to the slurry, and the mixture was stirred for 60 minutes at ambient temperature.

The solid was collected by suction filtration and dried under an IR heat lamp. The powder was transferred to an alumina crucible and heated uncovered from room temperature to 450° C. over the period of one hour, and held at 450° C. for an additional hour. The crucible and its contents were removed from the furnace and cooled naturally to room temperature.

An X-ray powder diffraction pattern of the calcined material showed only the tetragonal form of ZrO₂ with 7 nm crystals. Nitrogen porosimetry revealed a surface area of 81.5 m²/g, a pore volume of 0.38 cc/g, and an average pore diameter of 187 Å. The porosimetry data of this Example are reported in Table 6.

### Comparative Example G

Reaction of HfOCl₂.8H₂O with NH₄OH in water does not give HfO₂, calcined, as obtained via aqueous saturated NH₄Cl solution.

10.0 g HfOCl₂.8H₂O were dissolved in 200 mL deionized H₂O while stirring with a Teflon coated magnetic stirring bar in a 250 mL Pyrex beaker. With stirring, 3.5 mL concentrated NH₄OH were added to the hafnium solution. The pH of the slurry, measured with multi-color strip pH paper, was about 8-9. The resulting slurry was stirred for 60 minutes at ambient temperature.

The solid was collected by suction filtration and dried under an IR heat lamp. The powder was transferred to an alumina crucible and heated uncovered from room temperature to 450° C. over the period of one hour, and held at 450° C. for an additional hour. The crucible and its contents were removed from the furnace and cooled naturally to room temperature.

An X-ray powder diffraction pattern of the calcined material showed it to be amorphous. Nitrogen porosimetry revealed a surface area of 62.5 m²/g, a pore volume of 0.05 cc/g, and an average pore diameter of 29 Å. The porosimetry data of this Example are reported in Table 6.

### Example 17

This example, using HfOCl₂.8H₂O in aqueous saturated NH₄Cl solution, illustrates the synthesis of calcined HfO₂ product.

10.0 g HfOCl₂.8H₂O were dissolved in 200 mL aqueous NH₄Cl solution saturated at room temperature, while stirring with a Teflon coated magnetic stirring bar in a 250 mL Pyrex beaker. With stirring, 3.5 mL concentrated NH₄OH were added to the hafnium solution. The pH of the slurry, measured with multi-color strip pH paper, was about 8. The resulting slurry was stirred for 60 minutes at ambient temperature.

The solid was collected by suction filtration and dried under an IR heat lamp. The powder was transferred to an alumina crucible and heated uncovered from room temperature to 450° C. over the period of one hour, and held at 450° C. for an additional hour. The crucible and its contents were removed from the furnace and cooled naturally to room temperature.

An X-ray powder diffraction pattern of the calcined material showed only the monoclinic form of HfO₂ with crystallites approximately 8-11 nm in size. Nitrogen porosimetry revealed a surface area of 49.9 m²/g, a pore volume of 0.20 cc/g, and an average pore diameter of 161 Å. The porosimetry data of this Example are reported in Table 6.

### Example 18

This example, using HfOCl₂.8H₂O illustrates the synthesis of calcined product via addition of NH₄Cl after forming the HfO₂ precipitate.

10.0 g HfOCl₂.8H₂O were dissolved in 200 mL deionized H₂O at room temperature while stirring with a Teflon coated magnetic stirring bar in a 250 mL Pyrex beaker. With stirring, 3.5 mL concentrated NH₄OH were added to the zirconium solution. After a few minutes, 85 g NH₄Cl were added to the slurry, and the mixture was stirred for 60 minutes at ambient temperature.

The solid was collected by suction filtration and dried under an IR heat lamp. The powder was transferred to an alumina crucible and heated uncovered from room temperature to 450° C. over the period of one hour, and held at 450° C. for an additional hour. The crucible and its contents were removed from the furnace and cooled naturally to room temperature.

An X-ray powder diffraction pattern of the calcined material showed only the monoclinic form of HfO₂ with crystallites 8-10 nm in size. Nitrogen porosimetry revealed a surface area of 53.2 m²/g, a pore volume of 0.17 cc/g, and an average pore diameter of 130 Å.

The surface area and pore characteristics of the products of the examples are reported in the following Table 6.

### Comparative Example H

This example illustrates how a Y-mixer pumped at a relatively slow solution/mixture flow rate does not ultimately produce a calcined TiO₂ product having the surface area and porosity properties of TiO₂ made by processes of this disclosure.

A 50 wt % solution of TiCl₄ in H₂O (28.0 mL) was added to a saturated aqueous solution of NH₄Cl (200 mL). This caused precipitation of NH₄Cl to make an aqueous slurry. Separately, NH₄OH (30 mL, 14.8 M) was added to a saturated aqueous solution of NH₄Cl (200 mL). No precipitate formed. The slurry and the solution were each stirred separately using Teflon®-coated magnetic stirring bars in 500 mL Pyrex® Erlenmeyer flasks. A Cole-Parmer peristaltic pump with two size 16 pump heads and silicone tubing was used to combine the slurry and the solution in a polypropylene Y-joint with a combined flow rate of approximately 160 mL/min., i.e., each stream was pumped at about 80 mL/min. As the two streams were combined, a white slurry formed. The slurry flowed into a beaker and was stirred using a Teflon®-coated magnetic stirring bar. The pH of the resulting slurry, measured with multi-color strip pH paper, was about 8.

The solid was collected by vacuum filtration (0.45 μm, Nylon filter) and air dried for several days at room temperature to give a white solid. The solid was then pulverized using a mortar/pestle, transferred to an alumina tray, heated uncovered (calcined) in a tube furnace from room temperature to 400° C. over the period of 1 h, and held at 400° C. for 20 h. The firing was done under a constant air flow to help remove the sublimed NH₄Cl byproduct. The furnace was allowed to cool naturally to room temperature, and the fired material was recovered.

An X-ray powder diffraction pattern of the calcined material showed a predominance of anatase and traces of rutile and brookite. Nitrogen porosimetry revealed a surface area of 75 m²/g, a pore volume of 0.38 cc/g, and an average pore diameter of 201 Å. The porosimetry data of this Example are reported in Table 6.

### Example 19

This example illustrates how a T-mixer pumped at a relatively fast solution/mixture flow rate ultimately produces a calcined TiO₂ product having high surface area and porosity.

A 50 wt % solution of TiCl₄ in H₂O (56.0 mL) was added to a saturated aqueous solution of NH₄Cl (400 mL) with stirring in a 600 mL Pyrex beaker. This caused precipitation of NH₄Cl to make an aqueous slurry. Separately, NH₄OH (60 mL, 14.8 M) was added to a saturated aqueous solution of NH₄Cl (400 mL) with stirring in a 600 mL Pyrex beaker. No precipitate formed. The slurry and the solution were each rapidly stirred, separately, using Teflon®-coated magnetic stirring bars. Two separate identical Cole-Parmer Masterflex® L/S® peristaltic pumps, each fitted with 0.19 inch inner diameter silicone tubing, were used to combine the slurry and the solution, respectively, in a polypropylene T-joint at a combined flow rate of approximately 2000 mL/min, i.e., each stream was pumped at about 1000 mL/min. As the two streams combined, a white slurry formed. The slurry was directed into a 1 L glass bottle equipped with a polypropylene-coated steel stirring blade whose speed was controlled by an overhead motor. The stirrer speed was adjusted to keep the slurry rapidly mixed. The pH of the resulting slurry, measured with multi-color strip pH paper, was about 8.

The solid was collected by vacuum filtration (0.45 μm, Nylon filter) and dried under an IR heat lamp overnight. The solid was then pulverized using a mortar/pestle, transferred to an alumina tray, heated uncovered (calcined) in a tube furnace from room temperature to about 450° C. over the period of 1 h, and held at 450° C. for 1 h. The firing was done under a constant air flow to help remove the sublimed NH₄Cl porogen. The furnace was allowed to cool naturally to room temperature, and the fired material was recovered.

An X-ray powder diffraction pattern of the calcined material showed a predominance of anatase and a small amount of rutile. The amount of anatase was estimated to be about 95% by comparing the observed intensity of the strongest diffraction line for anatase with the observed intensity of the strongest diffraction line of rutile. Nitrogen porosimetry revealed a surface area of 93 m²/g, a pore volume of 0.56 cc/g, and an average pore diameter of 239 Å. The porosimetry data of this Example are reported in Table 6.

TABLE 6

| | | | | Ave. |
|---|---|---|---|---|
| | | Surface | Pore | Pore |
| | | Area, | Vol. | Diam. |
| Example | Material | m²/g | (cc/g) | (Å) |
| Comparative A uncalcined | TiO₂ | 398 | 0.37 | 37 |
| Comparative A calcined | | 72 | 0.17 | 95 |
| Comparative B uncalcined | | 215 | 0.17 | 31 |
| Comparative B calcined | | 70 | 0.25 | 146 |
| Comparative C | | 75.8 | 0.24 | 129 |
| Comparative D-I | | 82 | 0.4 | 193 |
| Comparative D-II | | 74 | 0.37 | 202 |
| Comparative D-III | | 109 | 0.28 | 105 |
| 1 | | 88 | 0.72 | 325 |
| 2 | | 84 | 0.78 | 371 |
| 3 | | 89 | 0.65 | 293 |
| 4 | | 86 | 0.93 | 435 |
| 5 | | 91 | 0.63 | 276 |
| 6 | | 89 | 0.56 | 251 |
| 7 | | 78 | 0.74 | 378 |
| 8 | | 88 | 0.68 | 313 |
| 9 | | 80 | 0.52 | 260 |
| 10 | | 511 | 0.86 | 68 |
| Comparative E | | 61 | 0.34 | 223 |
| 11 | | 526 | 0.47 | 35 |
| Comparative F | ZrO₂ | 63.4 | 0.13 | 84 |
| 15 | | 84 | 0.31 | 146 |
| 16 | | 81.5 | 0.38 | 187 |
| Comparative G | HfO₂ | 62.5 | 0.05 | 29 |
| 17 | | 49.9 | 0.20 | 161 |
| 18 | | 53.2 | 0.17 | 130 |
| Comparative H | TiO₂ | 75 | 0.38 | 201 |
| 19 | | 93 | 0.56 | 239 |

The data of Table 6 show that this disclosure provides mesoporous products having high surface areas and high pore volumes and high average pore diameters. While the surface area of the uncalcined titanium-containing product of Comparative Examples A and B was high it was not as high as the uncalcined product of Example 10. Also, the pore volume and average pore diameter of the uncalcined product of Comparative Examples A and B was lower than that of titanium-containing product of Example 10.

While the surface area of the calcined product of Comparative Example D-III was higher than that of Examples 1-9 the pore volume and average pore diameter of the calcined product of Comparative Example D-III was much lower than that of the calcined product of Examples 1-9. Moreover, while the surface area of the product of example D-I was slightly higher than Examples 7 and 9, the pore volume and average pore diameter were lower.

### Example 20

This example describes the synthesis of luminescent samarium-doped TiO₂ in accordance with this disclosure. The solvent had low solubility for the ammonium chloride generated in the reaction.

A photoluminescent samarium-doped anatase TiO₂ is easily synthesized from titanium oxychloride and base in a solvent having low solubility for the halide compound generated in the reaction.

0.38 g SmCl₃.6H₂O were dissolved in about 2 mL deionized water in a 400 mL Pyrex beaker. 200 mL saturated aqueous NH₄Cl solution were mixed with the samarium solution by stirring with a Teflon coated magnetic stirring bar. 20.0 g (14 mL) of 50% wt TiCl₄ in H₂O were added to the samarium-NH₄Cl solution, followed by the addition of 15 mL concentrated NH₄OH. The pH of the slurry, measured with multi-color strip pH paper, was about 8. The resulting slurry was stirred for 60 minutes at ambient temperature. The Ti to Sm mole ratio was about 51 to about 1.

The solid was collected by suction filtration and dried under an IR heat lamp. The product was powdered in a mortar and then transferred to an alumina boat and heated uncovered in a tube furnace, under flowing air, from room temperature to 450° C. over the period of one hour, and held at 450° C. for an additional hour to ensure removal of the volatile NH₄Cl. Power was removed from the furnace and it was allowed to cool naturally to room temperature.

An X-ray powder diffraction pattern of the calcined material showed broad lines of anatase and from the width of the strongest peak an average crystal size of 14 nm was estimated. A very small amount of the brookite form of TiO₂ was also present. The fired material luminesced orange-red under a hand-held UV lamp with 254-nm excitation.

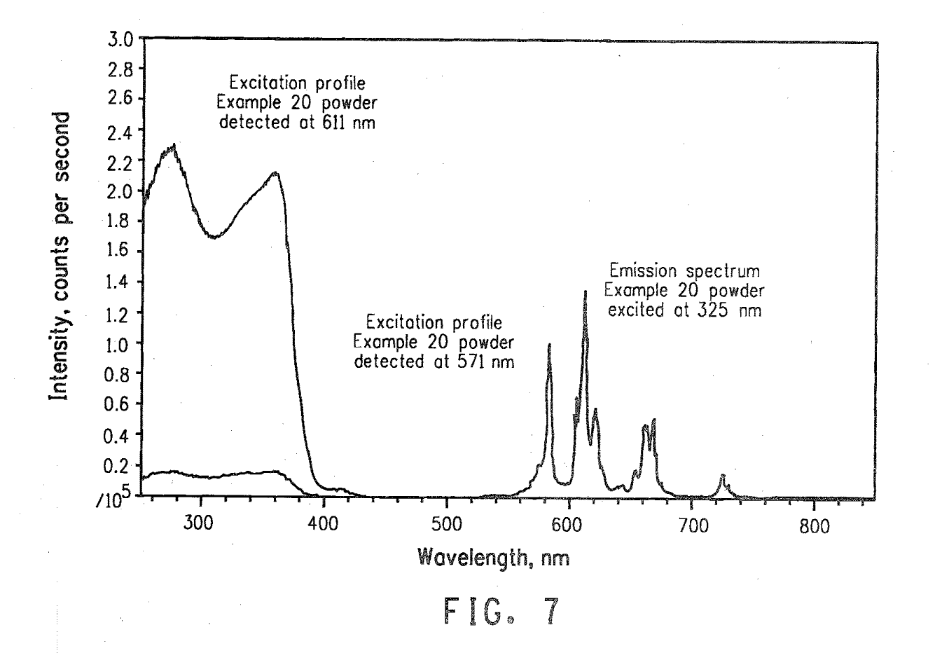

The room temperature emission-excitation spectra for the new phosphor were recorded and are shown in Excitation-Emission FIG. 7. Characteristic samarium emission peaks are seen. The results clearly show that the samarium is in the TiO₂ structure, and not present as a separate phase, because the excitation spectrum matches the absorption spectrum of anatase, i.e., absorption occurs in the band gap region of anatase

### Example 21

This example describes synthesis of a photoluminescent samarium-doped anatase TiO₂ in accordance with this disclosure. The solvent had low solubility for the ammonium chloride generated in the reaction.

0.084 g SmCl₃.6H₂O were dissolved in about 3 mL deionized water in a 400 mL Pyrex beaker. 200 mL saturated aqueous NH₄Cl solution were mixed with the samarium solution by stirring with a Teflon coated magnetic stirring bar. 20.0 g (14 mL) of 50% wt TiCl₄ in H₂O were added to the samarium-NH₄Cl solution, followed by the addition of 15 mL concentrated NH₄OH. The pH of the slurry, measured with multi-color strip pH paper, was about 8. The resulting slurry was stirred for 60 minutes at ambient temperature. The Ti to Sm mole ratio was about 229 to about 1.

The solid was collected by suction filtration and dried under an IR heat lamp. The product was powdered in a mortar and then transferred to an alumina boat and heated uncovered in a tube furnace, under flowing air, from room temperature to 450° C. over the period of one hour, and held at 450° C. for an additional hour to ensure removal of the volatile NH₄Cl. Power was removed from the furnace and it was allowed to cool naturally to room temperature.

An X-ray powder diffraction pattern of the calcined material showed broad lines of anatase and from the width of the strongest peak an average crystal size of 14 nm was estimated. A very small amount of the brookite form of TiO₂ was also present. The fired material luminesced orange-red under hand-held UV lamps with 254 nm excitation and 365 nm excitation, respectively.

### Example 22

This example describes the synthesis of a photoluminescent samarium-doped anatase TiO₂ in accordance with the disclosure. The solvent had low solubility for the ammonium chloride generated in the reaction.

0.19 g SmCl₃.6H₂O were dissolved in about 3 mL deionized water in a 400 mL Pyrex beaker. 200 mL saturated aqueous NH₄Cl solution were mixed with the samarium solution by stirring with a Teflon coated magnetic stirring bar. 20.0 g (14 mL) of 50% wt TiCl₄ in H₂O were added to the samarium-NH₄Cl solution, followed by the addition of 15 mL concentrated NH₄OH. The pH of the slurry, measured with multi-color strip pH paper, was about 8. The resulting slurry was stirred for 60 minutes at ambient temperature. The Ti to Sm mole ratio was about 101 to about 1.

The solid was collected by suction filtration and dried under an IR heat lamp. The uncalcined powder did not luminesce under hand-held UV lamps with 254-nm excitation and 365 nm excitation, respectively. The product was powdered in a mortar and then transferred to an alumina boat and heated uncovered in a tube furnace, under flowing air, from room temperature to 450° C. over the period of one hour, and held at 450° C. for an additional hour to ensure removal of the volatile NH₄Cl. Power was removed from the furnace and it was allowed to cool naturally to room temperature.

An X-ray powder diffraction pattern of the calcined material showed broad lines of anatase and from the width of the strongest peak an average crystal size of 16 nm was estimated. A very small amount of the brookite form of TiO₂ was also present. The fired material luminesced orange-red under hand-held UV lamps with 254 nm excitation and 365 nm excitation, respectively.

In Table 7 the anatase-to-rutile structural phase transition temperature is compared to that of undoped titanium dioxide. Samples were held at each temperature for 4 hours.

TABLE 7

| | | Sm-doped TiO₂ |
|---|---|---|
| Temperature (° C.) | TiO₂ undoped¹ | (Ti:Sm = 101:1)² |
| 450 | A | 97% A + 3% B |
| 650 | R | — |
| 800 | — | 97% A + 3% B |
| 950 | — | 25% A + 75% R |

A = Anatase;
B = Brookite;
R = Rutile
¹TiO₂ undoped was made in accordance with the procedure of Comparative Example K, set forth below.
²Sm-doped TiO₂ was made in accordance with Example 22.

### Comparative Example I

This example describes the synthesis of a terbium-doped anatase TiO₂, from terbium chloride, titanium oxychloride and NH₄OH (base) in a solvent having low solubility for the NH₄Cl generated in the reaction. The resulting terbium-doped titanium dioxide was not photoluminescent.

0.154 g TbCl₃ were dissolved in about 10 mL deionized water in a 400 mL Pyrex beaker. 200 mL saturated aqueous NH₄Cl solution were mixed with the terbium solution by stirring with a Teflon coated magnetic stirring bar. 20.0 g (14 mL) of 50% wt TiCl₄ in H₂O were added to the samarium-NH₄Cl solution, followed by the addition of 15 mL concentrated NH₄OH. The pH of the slurry, measured with multi-color strip pH paper, was about 8. The resulting slurry was stirred for 60 minutes at ambient temperature. The Ti to Tb mole ratio was about 90 to 1.

The solid was collected by suction filtration and dried under an IR heat lamp. The uncalcined powder did not luminesce under hand-held UV lamps with 254-nm excitation and 365 nm excitation, respectively. The product was powdered in a mortar and then transferred to an alumina boat and heated uncovered in a tube furnace, under flowing air, from room temperature to 450° C. over the period of one hour, and held at 450° C. for an additional hour to ensure removal of the volatile NH₄Cl. Power was removed from the furnace and it was allowed to cool naturally to room temperature.

An X-ray powder diffraction pattern of the calcined material showed broad lines of anatase and from the width of the strongest peak an average crystal size of 14 nm was estimated. A very small amount of the brookite form of TiO₂ was also present. The fired material did not luminesce under hand-held UV lamps with 254-nm excitation and 365 nm excitation, respectively.

### Comparative Example J

This example describes the synthesis of a europium-doped anatase TiO₂, synthesized from europium nitrate, titanium oxychloride and NH₄OH (base) in a solvent having low solubility for the NH₄Cl generated in the reaction. The europium-doped titanium dioxide was not photoluminescent.

0.22 g Eu(NO₃)₃ were dissolved in about 3 mL deionized water in a 400 mL Pyrex beaker. 200 mL saturated aqueous NH₄Cl solution were mixed with the terbium solution by stirring with a Teflon coated magnetic stirring bar. 20.0 g (14 mL) of 50% wt TiCl₄ in H₂O were added to the samarium-NH₄Cl solution, followed by the addition of 15 mL concentrated NH₄OH. The pH of the slurry, measured with multi-color strip pH paper, was about 8. The resulting slurry was stirred for 60 minutes at ambient temperature. The Ti to Eu mole ratio was about 81 to 1.

The solid was collected by suction filtration and dried under an IR heat lamp. The uncalcined powder exhibited a red luminesce under a hand-held UV lamps with 365 nm excitation. The product was powdered in a mortar and then transferred to an alumina boat and heated uncovered in a tube furnace, under flowing air, from room temperature to 450° C. over the period of one hour, and held at 450° C. for an additional hour to ensure removal of the volatile NH₄Cl. Power was removed from the furnace and it was allowed to cool naturally to room temperature.

An X-ray powder diffraction pattern of the calcined material showed broad lines of anatase and from the width of the strongest peak an average crystal size of 12 nm was estimated. A very small amount of the brookite form of TiO₂ was also present. The fired material did not luminesce under hand-held UV lamps with 254-nm excitation and 365 nm excitation, respectively.

### Comparative Example K

37.5 mL concentrated NH₄OH were added to about 500 mL n-propanol while stirring with a Teflon coated magnetic stirring bar in a 1 L Pyrex beaker. With continued stirring, 35 mL of titanium oxychloride solution (50 wt. % TiCl₄ in water) were added to the NH₄OH-propanol solution. The resulting slurry with pH 6 was stirred for 1 hour at ambient temperature.

The solid was collected by suction filtration and dried under an IR heat lamp. The voluminous powder was transferred to alumina boats and heated uncovered, under flowing air in a tube furnace, from room temperature to about 450° C. over the period of one hour, and held at about 450° C. for an additional hour to ensure removal of the volatile NH₄Cl. The furnace was allowed to cool naturally to room temperature, and the fired material was recovered. An X-ray powder diffraction pattern of the calcined material showed only the broad lines of anatase.

A portion of this 450° C. calcined material was heated in an alumina boat over a period of two hours to 600° C. and held at this temperature for one hour. An X-ray powder diffraction pattern of the 600° C. calcined material showed only anatase and no rutile.

Another portion of the 450° C. calcined material was heated in an alumina boat over a period of two hours to 650° C. and held at this temperature for one hour. An X-ray powder diffraction pattern of the 650° C. calcined material showed a mixture of anatase and rutile estimated to be about 60% anatase and 40% rutile.

What is claimed is:

1. A process for making luminescent titanium dioxide, comprising:
precipitating a halide salt and a hydrolyzed compound comprising titanium from a reaction mixture comprising a source of samarium, a titanium starting material selected from the group consisting of titanium tetrachloride, titanium oxychloride, and mixtures thereof, a base selected from the group consisting of ammonium hydroxide, ammonium carbonate, ammonium bicarbonate, tetramethyl ammonium hydroxide or tetraethyl ammonium hydroxide or mixture thereof, and a solvent selected from the group consisting of ethanol, n-propanol, i-propanol, dimethyl acetamide, alcoholic ammonium halide and aqueous ammonium halide and mixtures thereof to form a precipitate; and
removing the halide salt from the precipitate to recover a samarium-doped oxide of titanium.

2. The process of claim 1 wherein the halide salt is ammonium chloride.

3. The process of claim 1 wherein the halide salt is ammonium halide, tetramethyl ammonium halide or tetraethyl ammonium halide or mixtures thereof.

4. The process of claim 1 wherein the halide salt is removed by heating the precipitate to a temperature of at least 350° C.

5. The process of claim 1 wherein the hydrolyzed compound comprising titanium is derived from a titanium halide selected from the group consisting of titanium tetrachloride, titanium oxychloride and mixtures thereof.

6. The process of claim 1 wherein the reaction mixture is formed by the steps, in order, of contacting the base and the solvent to form a solution or a mixture and adding the titanium starting material and the source of samarium to the solution or mixture.

7. The process of claim 1 wherein the reaction mixture is formed, in order, by mixing the titanium starting material and the source of samarium to form a first mixture, mixing the solvent and the base to form a base-solvent and mixing the first mixture with the base-solvent to form the reaction mixture.

8. The process of claim 1 wherein the source of samarium is selected from the group consisting of SmCl₃, SmCl₃.6H₂O, Sm(O₂CCH₃)₃.2H₂O, Sm(NO₃)₃.6H₂O, and Sm₂(SO₄)₃.8H₂O and mixtures thereof.

9. The process of claim 1 wherein the samarium-doped titanium dioxide is substantially in an anatase crystalline form.

10. The process of claim 9 wherein the titanium dioxide is substantially in the anatase crystalline form at temperatures below about 950° C.

11. The process of claim 1 wherein the samarium is included as substituted sites in the titanium dioxide.
